(19) United States
(12) Patent Application Publication
(10) Pub. No.: US 2025/0171669 A1
(43) Pub. Date: May 29, 2025

(54) UNDERWATER ANIMAL TAGGING ADHESIVES AND METHODS OF MAKING AND USING THE SAME

(71) Applicant: Trustees of Tufts College, MEDFORD, MA (US)

(72) Inventors: Fiorenzo G. Omenetto, Lexington, MA (US); Marco Lo Presti, Arlington, MA (US)

(21) Appl. No.: 18/967,019

(22) Filed: Dec. 3, 2024

Related U.S. Application Data
(63) Continuation of application No. PCT/US2023/067810, filed on Jun. 2, 2023.
(60) Provisional application No. 63/349,005, filed on Jun. 3, 2022.
(60) Provisional application No. 63/476,943, filed on Dec. 22, 2022.

(51) Int. Cl. C09J 189/00

(52) U.S. Cl. CPC C09J 189/00

(57) ABSTRACT

A coacervate-based adhesive composition and methods of making and using the same are disclosed. The composition includes a dense phase of coacervate formed by mixing a dopamine-substituted silk fibroin solution and tannic acid. The tannic acid is present in an amount sufficient to initiate complexing and/or cross-linking of the adhesive composition. The adhesive has many useful applications, but one particularly valuable application is expected to involve adhesive application directly to the skin or outer surface of marine animals, such as sharks.

### CROSS-REFERENCE TO RELATED APPLICATIONS

This application is a continuation of PCT International Application Serial Number PCT/US2023/067810 (Attorney Docket No. 2095.0543), filed Jun. 2, 2023, and published as WO2024/006607. PCT International Application Serial Number PCT/US2023/067810 is related to and claims priority to U.S. Provisional Pat. App. No. 63/349,005 (Attorney Docket No. 2095.0409), filed Jun. 3, 2022; and U.S. Provisional Pat. App. No. 63/476,943 (Attorney Docket No. 2095.0410), filed Dec. 22, 2022. Each of the aforementioned patent applications are incorporated herein by reference in their entireties for all purposes.

### STATEMENT REGARDING FEDERALLY FUNDED RESEARCH

This invention was made with government support under grant N00014-19-1-2399 awarded by the United States Navy. The government has certain rights in the invention.

### BACKGROUND

In the field of silk-based adhesives, synthetic derivatives have long been favored due to the improved performance that can be achieved. More recently, however, biocompatible products are increasingly preferred. Some attempts at making biocompatible adhesives from natural products exist, but the performance of the biocompatible adhesives has not matched the performance of synthetic derivatives.

One particularly challenging adhesive task is the fast labeling of marine animals. In particular, shark skin is a very challenging surface for adhesion and current adhesives do not provide adequate adhesive performance for tagging purposes.

Thus, there remains a need for improved adhesives that are biocompatible with improved performance. A need exists for improved curable adhesives for both dry and underwater use. A need exists for adhesives that are suitable for fast tagging of marine animals.

### SUMMARY

In an aspect, the present disclosure provides a coacervate-based adhesive. The adhesive includes a dense phase of a coacervate formed by mixing a dopamine-substituted silk fibroin solution and tannic acid in a ratio by weight of silk fibroin protein to tannic acid of between 1:10 and 100:1. A light phase of the coacervate can optionally be an aqueous solution containing unreacted dopamine-substituted silk fibroin and unreacted tannic acid. The coacervate-based adhesive can optionally be substantially free of the light phase.

In another aspect, the present disclosure provides a method of making a coacervate-based adhesive. The method includes mixing a dopamine-substituted silk fibroin solution and tannic acid in a ratio by weight of silk fibroin protein to tannic acid of between 1:10 and 100:1, thereby forming a coacervate comprising a dense phase and a light phase.

In a further aspect, the present disclosure provides a method of using the coacervate-based adhesive disclosed herein. The method includes contacting two articles together with an adhesive amount of the coacervate-based adhesive, thereby adhering the two articles to one another.

### BRIEF DESCRIPTIONS OF THE DRAWINGS

FIG. 1 is a semi-log plot of coacervate recovery at different mass ratios. Each point is the average of 3 trials, error bars show standard deviation.

FIG. 2 is a plot of shear strength of dry and underwater adhesives, as shown in Example 2.

### DETAILED DESCRIPTION

### Definitions

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” and “approximately” are used as equivalents and may be understood to permit standard variation as would be understood by those of ordinary skill in the art; and (v) where ranges are provided, endpoints are included.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

It should be appreciated that compositions that undergo some chemical transformation during their use can be described in various ways. For instance, dissolving NaCl in water can be described as water having an NaCl concentration or water having a concentration of Na⁺ and Cl⁻ ions. In the present disclosure, components of chemical compositions can be described either as the form they take prior to any chemical transformation or the form they take following the chemical transformation. If there is any ambiguity to a person having ordinary skill in the art, the assumption should be that the component is being described in the context of the particular composition being described (i.e., if describing a finished product or an intermediary after a given chemical transformation, then the chemically transformed entity is being described, and if describing a starting product or intermediary prior to the chemical transformation, then the untransformed entity is being described.

The present disclosure relates to adhesive compositions. Typically, adhesive compositions are applied in thin layers or films. As used here, the term “film” refers to a layer of material, either solid or liquid, which has a thickness suitable for use in an adhesive application.

In an aspect, the present disclosure provides a coacervate-based adhesive composition. The coacervate-based adhesive composition comprises a dense phase of a coacervate. The dense phase of a coacervate is formed by mixing a dopamine-substituted silk fibroin solution and tannic acid. The light phase of the coacervate-based adhesive can be optionally an aqueous solution that contains an unreacted dopamine-substituted silk fibroin and unreacted tannic acid. The coacervate-based adhesive composition wherein the coacervate-based adhesive is optionally substantially free of the light phase. In certain cases, the light phase of the coacervate-based adhesive is the aqueous phase. In certain cases, the coacervate-based adhesive is substantially free of the light phase. This complexing occurs in a fashion understood by those having ordinary skill in the art. A non-limiting description of this complexing and crosslinking is provided in Example 1.

In some aspects, the dense phase of a coacervate can be formed by mixing a dopamine-substituted silk fibroin and tannic acid in a ratio by weight between 1:10 and 100:1. in some cases, the ratio by weight of dopamine-substituted silk fibroin to tannic acid can be at least 1:10, at least 1:5, at least 1:4, at least 1:3, at least 1:2, at least 2:3, at least 3:4, at least 4:5, at least 1:1, at least 5:1, at least 10:1, at least 15:1, at least 20:1, at least 25:1, at least 30:1, at least 40:1, at least 50:1, or at least 60:1. In some cases, the ratio by weight of dopamine-substituted silk fibroin to tannic acid can be at most 100:1, at most 90:1, at most 80:1, at most 75:1, at most 70:1, at most 65:1, at most 60:1, at most 50:1, at most 45:1, at most 40:1, at most 30:1, at most 25:1, at most 22:1, at most 20:1, at most 15:1, at most 10:1, at most 7:1, at most 6:1, at most 5:1, at most 3:1, at most 1:1, or at most 1:2.

In some aspects, the tannic acid can be present in the adhesive composition in a dry-solids-basis amount by weight relative to the dry-solid-basis amount by weight of the silk fibroin protein and the dopamine of between 0.001% and 1.0%, including but not limited to, between 0.005% and 0.9%, between 0.01% and 0.75%, between 0.1% and 0.5%, between 0.025% and 0.25%, between 0.05% and 0.1%, between 0.25% and 0.85%, or between 0.002% and 0.05%. In some cases, the tannic acid can be present in an amount of at least 0.005 mg per 1 mg of dopamine-modified silk fibroin.

In some aspects, the coacervate-based adhesive composition contains components that are present in naturally occurring organisms. These components may be covalently or ionically or otherwise linked to one another. In other words, two natural components that present in naturally occurring organisms can be covalently bound to one another and still be defined as a component that is present in naturally occurring organisms. Dopamine-substituted silk fibroin is not known to be present in naturally occurring organisms, but its made of components that are present in naturally occurring organisms.

The present disclosure provides a method of making coacervate-based adhesive. The method including mixing a dopamine-substituted silk firoin solution and tannic acid in a ratio by weight for dopamine-substituted silk fibroin to tannic acid between 1:10 and 100:1 or one of the aforementioned ratios identified above. The mixing thereby forming a coacervate. The coacervate can comprise a dense phase and a light phase.

In some aspects, the dense phase of a coacervate is formed by mixing a dopamine-substituted silk fibroin solution and tannic acid and the light phase of the coacervate-based adhesive can be optionally an aqueous solution that contains an unreacted dopamine-substituted silk fibroin and unreacted tannic acid. The coacervate-based adhesive composition wherein the coacervate-based adhesive is optionally substantially free of the light phase. In certain cases, the light phase of the coacervate-based adhesive is the aqueous phase. In certain cases, the coacervate-based adhesive is substantially free of the light phase. In certain cases, the method includes removing at least a portion of the light phase from the coacervate. In some cases, the method includes optionally isolating at least a portion of the dense phase from the light phase.

In some aspects, the method of making the coacervate-based adhesive includes a mass ratio of tannic acid to silk fibroin that is substantially 1:1.

In some aspects, the coacervate-based adhesive comprises a dry adhesive strength that is greater than a first comparison dry adhesive strength. In some cases, the first comparison dry adhesive strength is from a first comparison coacervate-based adhesive that replaces the dopamine-substituted silk fibroin solution with an unmodified silk fibroin solution and is otherwise identical to the coacervate-based adhesive. In some aspects, the dry adhesive strength of the is optionally 5% greater, 10% greater, 25% greater, 50% greater, 75% greater, or 100% greater than the first comparison dry adhesive strength, wherein the dry adhesive strength is optionally at least 500 kPa, at least 750 kPa, at least 1 MPa, at least 2 MPa, at least 3 MPa, or at least 5 MPa.

In some aspects, the method of forming the coacervate-based adhesive comprises a dry adhesive strength that is greater than a first comparison dry adhesive strength. In some cases, the first comparison dry adhesive strength is from a first comparison coacervate-based adhesive that replaces the dopamine-substituted silk fibroin solution with an unmodified silk fibroin solution and is otherwise identical to the coacervate-based adhesive. In some aspects, the dry adhesive strength of the is optionally 5% greater, 10% greater, 25% greater, 50% greater, 75% greater, or 100% greater than the first comparison dry adhesive strength, wherein the dry adhesive strength is optionally at least 500 kPa, at least 750 kPa, at least 1 MPa, at least 2 MPa, at least 3 MPa, or at least 5 MPa.

In some aspects, the composition or method comprises the coacervate-based adhesive which has a wet adhesive strength that is greater than a first comparison wet adhesive strength. In some aspects, first comparison wet adhesive strength is from a first comparison coacervate-based adhesive that replaces the dopamine-substituted silk fibroin solution with an unmodified silk fibroin solution and is otherwise identical to the coacervate-based adhesive. The wet adhesive strength is optionally 5% greater, 10% greater, 25% greater, 50% greater, 75% greater, or 100% greater than the first comparison wet adhesive strength, wherein the wet adhesive strength is optionally at least 200 kPa, at least 500 kPa, at least 750 kPa, at least 1 MPa, or at least 2 MPa.

In some aspects, the composition or method comprises the coacervate-based adhesive which has a dry adhesive strength that is greater than a second comparison dry adhesive strength. In some aspects, the second comparison dry adhesive strength is from a first comparison coacervate-based adhesive that replaces the dopamine-substituted silk fibroin solution with a polyethylene glycol solution and is otherwise identical to the coacervate-based adhesive. The dry adhesive strength is at least 25%, at least 50%, at least 75%, at least 100%, or at least 125% of the second comparison dry adhesive strength.

In some aspects, the composition or method comprises the coacervate-based adhesive which has a wet adhesive strength that is greater than a second comparison wet adhesive strength. In some aspects, the second comparison wet adhesive strength is from a first comparison coacervate-based adhesive that replaces the dopamine-substituted silk fibroin solution with a polyethylene glycol solution and is otherwise identical to the coacervate-based adhesive. The wet adhesive strength is at least 25%, at least 50%, at least 75%, at least 100%, or at least 125% of the second comparison wet adhesive strength.

Without wishing to be bound by any particular theory, these comparisons are believed to be applicable across a broad range of surfaces for adhering together, but they are particularly true for surfaces that are challenging for adhesion (e.g., adhering to shark skin). With respect to the comparative values, it is believed that the values hold for the vast majority of surfaces and the compositions disclosed herein provide superior performance over the comparison compositions. With respect to the absolute adhesion strength values, it is possible that the values may vary based on the surfaces or articles being adhered and a skilled artisan would recognize that the disclosed absolute values may be for a more limited set of surfaces. The adhesive strength may vary depending on the specific aqueous conditions and a skilled artisan would recognize that the presence of certain ions may enhance the adhesive strength. For some surfaces that are easier to adhere and some adhesion environments, the adhesive strength can be much higher than those discussed elsewhere herein, including peel strengths of greater than 1 N/mm, greater than 2 N/mm, or higher, with as high as 5 N/mm expected to be achievable with certain surfaces.

In addition to the impressive performance capabilities, the compositions described herein provided other unexpected results. Specifically, currently on the market, two-component epoxy resins are the state-of-the-art for repairing cracks in marine environments (e.g., swimming pools and the like). However, these products have a slow setting time and become rigid after curing. Moreover, they have been shown ineffective on biological tissues (by way of experiments on sharks and manatees), potentially due to the skin irritation. The inventors have discovered a composition that does not require curing time to be adhesive. Moreover, the inventive compositions described herein can remain flexible long after application, which makes them compatible with an animal's movements while maintaining adhesion.

In some aspects, the composition or method of making the coacervate-based adhesive comprises the polydopamine-substituted silk fibroin. In some aspects, the polydopamine-substituted silk fibroin has a degree of polydopamine-substitution of between 5% and 50%, between 10% and 40%, or between 25% and 35%. The degree of polydopamine-substitution is measured as a percentage by weight of polydopamine substituents related to the weight of the silk fibroin backbone. In some aspects, the polydopamine-substituted silk fibroin is polydopamine-substituted at one or more target amino acids. The one or more target amino acids are selected from the group consisting of cysteine, tyrosine, arginine, lysine, histidine, phenylalinine, proline, and combinations thereof. In some aspects, the the polydopamine-substituted silk fibroin is polydopamine-substituted at one or more tyrosines. In some aspects, polydopamine-substituted silk fibroin is the substituted with polydopamine having 15, 13, 12, 10, 9, or 8 polymeric units or less.

In some aspects, the silk fibroin backbone of the polydopamine-substituted silk fibroin can have a weight average molecular weight of between 25 kDa and 150 kDa. For example, the silk fibroin backbone can have a weight average molecular weight of between 30 kDa and 125 kDa. In some cases, the silk fibroin backbone can have a weight average molecular weight of between 35 kDa and 100 kDa. In some cases, the silk fibroin backbone can have a weight average molecular weight of between 25 kDa and 75 kDa. In some cases, the silk fibroin backbone can have a weight average molecular weight of between 100 kDa and 150 kDa. In some cases, the silk fibroin backbone can have a weight average molecular weight of between 50 kDa and 125 kDa. In some cases, the silk fibroin backbone can have a weight average molecular weight of between 40 kDa and 90 kDa. In some cases, the silk fibroin backbone can have a weight average molecular weight of between 55 kDa and 105 kDa. In some cases, the silk fibroin backbone can have a weight average molecular weight of between 45 kDa and 65 kDa.

In some aspects, the silk fibroin backbone of the polydopamine-substituted silk fibroin can have a number average molecular weight of between 25 kDa and 150 kDa. For example, the silk fibroin backbone can have a number average molecular weight of between 30 kDa and 125 kDa. In some cases, the silk fibroin backbone can have a number average molecular weight of between 35 kDa and 100 kDa. In some cases, the silk fibroin backbone can have a number average molecular weight of between 25 kDa and 75 kDa. In some cases, the silk fibroin backbone can have a number average molecular weight of between 100 kDa and 150 kDa. In some cases, the silk fibroin backbone can have a number average molecular weight of between 50 kDa and 125 kDa. In some cases, the silk fibroin backbone can have a number average molecular weight of between 40 kDa and 90 kDa. In some cases, the silk fibroin backbone can have a number average molecular weight of between 55 kDa and 105 kDa. In some cases, the silk fibroin backbone can have a number average molecular weight of between 45 kDa and 65 kDa.

In some aspects, the composition or method of making the coacervate-based adhesive comprises the polydopamine-substituted silk fibroin which is made by mixing silk fibroin with soluble dopamine in an aqueous solution. In some aspects, the polydopamine-substituted silk fibroin has a structure that is indistinguishable from a comparison structure that is made by mixing comparison silk fibroin with comparison soluble dopamine in a comparison aqueous solution. In some aspects, the soluble dopamine and/or the comparison soluble dopamine is dopamine hydrochloride.

In some aspects, the composition or method of making the coacervate-based adhesive comprises mixing silk fibroin with soluble dopamine in an aqueous solution. In some aspects, the mixing of silk fibroin with soluble dopamine in an aqueous solution uses a ratio by weight of silk fibroin to soluble polydopamine of between 1:2 and 10:1, between 1:1 and 5:1, or between 1.25:1 and 3:1, including but not limited to, at least 1:2, at least 1.5:1, at least 1:1, at least 1.1:1, at least 1.2:1, at least 1.25:1, at least 1.3:1, at least 1.4:1, at least 1.5:1, a least 1.75:1, at least 2:1, at least 3:1, or at least 4:1 and at most 10:1, at most 9:1, at most 8:1, at most 7:1, at most 6:1, at most 5:1, at most 4:1, at most 3:1, at most 2:1, or at most 1:1.

In some aspects, the composition or method of making the coacervate-based adhesive comprises mixing comparison silk fibroin with comparison soluble polydopamine in a comparison aqueous solution. In some aspects, the mixing of comparison silk fibroin with comparison soluble polydopamine uses a ratio by weight of comparison silk fibroin to comparison soluble polydopamine of between 1:2 and 10:1, between 1:1 and 5:1, or between 1.25:1 and 3:1, including but not limited to, at least 1:2, at least 1.5:1, at least 1:1, at least 1.1:1, at least 1.2:1, at least 1.25:1, at least 1.3:1, at least 1.4:1, at least 1.5:1, a least 1.75:1, at least 2:1, at least 3:1, or at least 4:1 and at most 10:1, at most 9:1, at most 8:1, at most 7:1, at most 6:1, at most 5:1, at most 4:1, at most 3:1, at most 2:1, or at most 1:1.

The present disclosure provides a method of using the coacervate-based adhesive. the method comprises contacting two articles together with an adhesive amount of the coacervate-based adhesive, thereby adhering the two articles to one another.

In some cases, the first article can be an animal, such as a marine animal, such as a fish or a marine mammal. In some cases, the second article can be a tag, such as a numbered tag, an electronic tag (e.g., radio transmitters), or another sensor that can be usefully applied to a marine animal or other article. In some cases, the first and/or second article can be water permeable, thereby allowing water to interact with the adhesive via penetration of the second article.

In one particular use case, the adhesives described herein can be used to adhere tags to marine animals, such as sharks. The examples below show testing to establish adequate adhesion with the very challenging surface of shark skin. Without wishing to be bound by any particular theory, it is believed that achieving adequate adhesion to shark skin is a baseline adhesion performance that can be broadly applied to other marine species with reasonable predictability (i.e., if it works on shark skin, it likely works on the exterior surface of most other species).

Other non-limiting examples of methods of using the adhesive are contemplated. As one example, during harvesting of fish, off-species catch could be tagged and then identified for isolation, with the disclosed adhesive providing the ability to rapidly adhere tags to marine species without the need for curing and containing only naturally-occurring components in many cases. As another example, swimming competitions in the wild could use the disclosed adhesive to adhere race numbers or other identifiers to racers, with the disclosed adhesive providing impressive adhesive strength despite the significant agitation that results from competitive swimming. As another example, the compositions could be useful as drug delivery systems for antibiotics or medications. They could be used to treat wounds in at-risk species, allowing for controlled release of therapeutic agents embedded therein. As yet another example, the compositions could be useful in fish farms. The issues with antibiotic use and release in fish farms (e.g., salmon farms) can lead to accumulation of antibiotics in the environment and development of antibiotic-resistant bacteria (e.g., as shown in studies involving the Chilean salmon industry). An antibiotic that is locally deployed in the compositions disclosed herein could be one useful step toward a more sustainable solution.

In general, the method of using can provide an adhesive strength that withstands shear forces and does not require curing. In some cases, the adhesive strength grows over time following application to a final adhesive strength.

In some cases, the method of using the coacervate-based adhesive includes maintaining the adhesive at a low temperature (e.g., below 15° C., below 10° C., below 5° C., etc.) to control the viscosity of the adhesive and retain structural integrity of the adhesive in a desired shape. This lowered temperature may reduce the surface tackiness of the adhesive making it easier to handle. In these cases, the method can include raising the temperature of the adhesive following the contacting.

### EXAMPLES

### Example 1

### Silk-Dopamine Adhesives Composite

A blend composed of Silk fibroin (SF) and dopamine was tested as a curable adhesive both in dry and underwater conditions and the results and technical information are all reported in a published scientific paper¹.

Briefly, dopamine 200 mM is dissolved in 7% silk solution and it self-polymerizes into polydopamine (PDA) (for 3 days) with the consequent formation of covalent binding between PDA oligomers and silk's tyrosine residues. The solution can be cast and dried as a solid film that can be cured with water or metals (iron is the most effective) that activate its adhesive properties.

A wide variety of material formats can be made out with this composition.

In some cases, a GPC measurement can demonstrate the covalent binding between silk's tyrosine and polydopamine oligomers and their correlation with adhesive strength measured through lap shear testing.

In some cases, the dense phase is a solid having temperature-varying mechanical properties. The dense phase can be used by heating, applying, and then cooling.

### Silk-Dopamine Coacervates

Tannic acid (TA) is a polyphenol composed of numerous phenol groups that have attracted interest due to its ability to cross-link functional polymers². In particular, when tannic acid is mixed with polyethylene glycol (PEG), it precipitates the polymer into a dense phase called coacervate which displays interesting underwater adhesive ability³. TA has also been used to precipitate silk into self-healing hydrogel for medical applications⁴ but with adhesive performance inferior compared to the coacervates obtained with PEG.

Recently, we have precipitated our SF-PDA solution with TA obtaining a dense phase that can be stored underwater for several days without losing its underwater adhesive ability. Its adhesive performance seems qualitatively similar to coacervates obtained with PEG, but it has to be measured. In a demonstrator video (biofabricate presentation) we managed to attach metal, glass, wood and porcine skin in an underwater environment without any curing procedures.

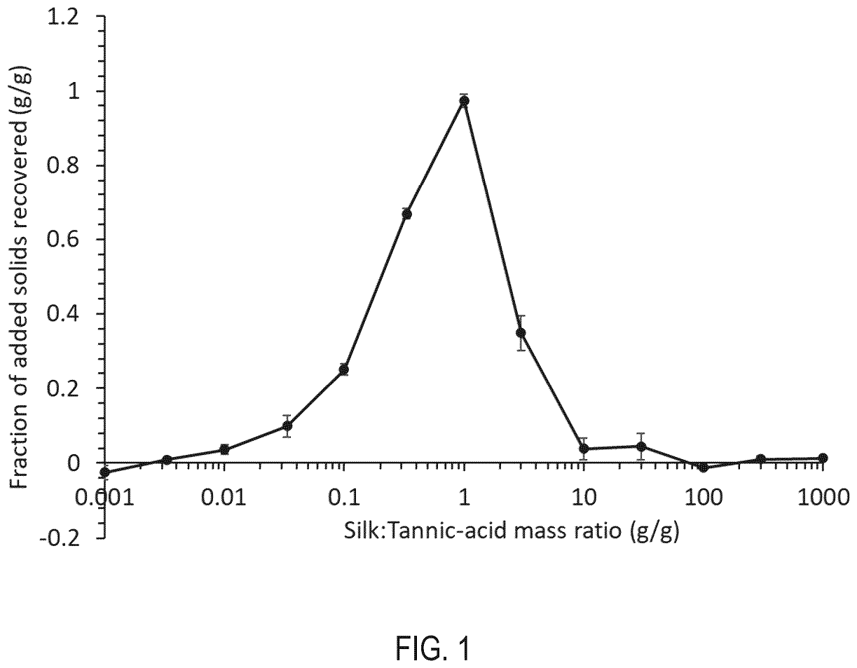

In order to further elucidate the mechanism of coacervation between silk and tannic acid, coacervates of the two were formed with various mass ratios of silk and tannic acid (FIG. 1). Solutions of silk and tannic acid were mixed and an insoluble precipitate formed instantly, the solution was centrifuged to pellet any precipitate, then the supernatant was decanted. The precipitate was washed twice with deionized water and the remaining solids were dried at 60 C for 12 hours. This figure shows that a 1:1 mass ratio of the two produces the largest mass of precipitate, recovering 97±2% of total added solids. Other mass ratios produced less optimal recoveries, however, an excess of tannic acid tended to lead to greater recovery than an excess of silk fibroin.

These silk-dopamine coacervates can display a thermoplastic behavior: they can be stored at 8° C. and become rigid and brittle, but when heated in an oven at 30-40° C. they return to an adhesive making it possible to control the viscosity of the adhesive.

### Example 2

The adhesive was prepared as described in Example 1 by mixing SF-PDA and TA. The dense phase was recovered by centrifugation (3000 rpm for 10 minutes), and the solid was transferred into a syringe for easy application onto the substrates. Approximately 100 uL of adhesive were deposited on an area of 25×7 mm, and the glass substrates were pressed together with a force of approximately 10N.

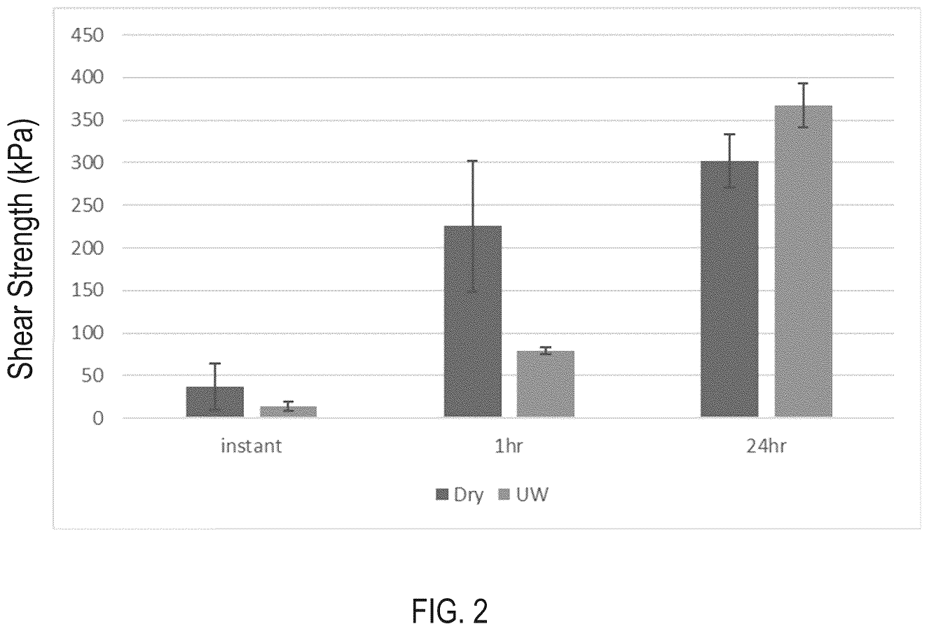

The adhesive was applied onto glass substrates, both in air and immersed in distilled water (BD water), and the adhesion was measured in instant single lap-shear tests, after 1 hour, and after 24 hours from the application. No additional curing was done. The results are shown in FIG. 2.

### Example 3

A coacervate-based adhesive was prepared as described in the examples above, but the boiling time during the silk fibroin regeneration process was varied in order to adjust the molecular weight of the silk fibroin backbone. Three boil times were used: 60 minutes; 120 minutes; and 180 minutes. One exemplary reference describing the impact of boil time on molecular weight is WO 2014/145002, which is incorporated herein in its entirety by reference, though Applicant does not wish to be bound by any particular theory with respect to the connection between the aforementioned boil times and any specific molecular weight distribution. Using techniques understood to those skilled in the art, the molecular weight distribution can be controlled or altered for desirable properties.

The resulting adhesives were used to adhere two pieces of shark skin together under simulated sea water (tap water with 3.5% NaCl by weight). An underwater T-peel test was performed. The 60-minute boil time yielded an adhesive that provided a 0.11 N/mm adhesion strength under the T-peel test. The 120-minute boil time yielded an adhesive that provided a 0.078 N/mm adhesion strength under the T-peel test. The 180-minute boil time yielded an adhesive that provided a 0.036 N/mm adhesion strength under the T-peel test.

### Example 4

A coacervate-based adhesive was prepared as described above. A small amount was applied to a water-permeable tag. Using a process that mimics the process used in nature to deploy probes onto the surface of marine animals, the water-permeable tag was remotely adhered to a shark skin surface. A fixed shark specimen (a deceased specimen) was placed inside an aquarium filled with simulated sea water and underwater tagging was attempted using a procedure similar to surgical tagging. Resistance tests were also conducted on the tag by simulating shark swimming and movements in water. The adhesive maintained performance throughout.

### Example 5

A coacervate-based adhesive was prepared as described in the examples above. Specifically, the procedure of Example 1 was repeated with a 60 minute boil time. A 10% by weight SF-PDA solution and 10% by weight TA solution were mixed in equal volumes and shaken using a vortex. The dense phase was collected by centrifuging at 3000 rpm for 10 minute sand transferred into a syringe for underwater application. In the same environment, a small piece of waterproof paper was adhered underwater to an inner surface of a beaker's vertical wall for each adhesive. The water was stirred constantly (125 RPM) to generate turbulence around the adhered paper and the adhesive performance was monitored. After 1 hour, both pieces of paper remained adhered. After 8 hours, the PVA-TA coacervate adhesive had failed and the corresponding piece of paper was released, while the coacervate-based adhesive of the present disclosure kept the paper adhered after 8 hours, and even after 5 days, 10 days, and 15 days, exhibiting remarkable adhesive longevity. For the purposes of animal sensing and/or tracking, the adhesive composition disclosed herein can provide adhesive performance that lasts long enough for meaningful monitoring and measurement, while using safe and natural ingredients.

### REFERENCES

Each reference listed below is hereby incorporated herein in its entirety by reference for all purposes.
1. Lo Presti, M., Rizzo, G., Farinola, G. M., & Omenetto, F. G. (2021). Bioinspired Biomaterial Composite for All-Water-Based High-Performance Adhesives. Advanced Science, 8(16), 2004786.
2. Chen, C., Yang, H., Yang, X., & Ma, Q. (2022). Tannie acid: A crosslinker leading to versatile functional polymeric networks: A review. RSC advances, 12(13), 7689-7711.
3. Peng, Q., Wu, Q., Chen, J., Wang, T., Wu, M., Yang, D., . . . & Zeng, H. (2021). Coacervate-Based Instant and Repeatable Underwater Adhesive with Anticancer and Antibacterial Properties. ACS Applied Materials & Interfaces, 13(40), 48239-48251.
4. Luo et al. (2020). A Highly Stretchable, Real-Time Self-Healable Hydrogel Adhesive Matrix for Tissue Patches and Flexible Electronics. Advanced Healthcare Materials, 9(4), 1901324.

1. A coacervate-based adhesive comprising:
a dense phase of a coacervate formed by mixing a dopamine-substituted silk fibroin solution and tannic acid in a ratio by weight of silk fibroin protein to tannic acid of between 1:10 and 100:1.

2. The coacervate-based adhesive of claim 1, wherein the coacervate-based adhesive contains only components that are present in naturally-occurring organisms.

3. The coacervate-based adhesive of claim 1, wherein a light phase of the coacervate is an aqueous solution containing unreacted dopamine-substituted silk fibroin and unreacted tannic acid.

4. The coacervate-based adhesive of claim 3, wherein the coacervate-based adhesive is substantially free of the light phase.

5. A method of making a coacervate-based adhesive, the method comprising:
mixing a dopamine-substituted silk fibroin solution and tannic acid in a ratio by weight of silk fibroin protein to tannic acid of between 1:10 and 100:1, thereby forming a coacervate comprising a dense phase and a light phase, wherein the dense phase is the coacervate-based adhesive.

6.-8. (canceled)

9. The coacervate-based adhesive of claim 1, wherein the coacervate-based adhesive has a dry adhesive strength that is greater than a first comparison dry adhesive strength, wherein the first comparison dry adhesive strength is from a first comparison coacervate-based adhesive that replaces the dopamine-substituted silk fibroin solution with an unmodified silk fibroin solution and is otherwise identical to the coacervate-based adhesive, wherein the dry adhesive strength is at least 5% greater than the first comparison dry adhesive strength, wherein the dry adhesive strength is at least 500 kPa.

10. The coacervate-based adhesive of claim 1, wherein the coacervate-based adhesive has a wet adhesive strength that is greater than a first comparison wet adhesive strength, wherein the first comparison wet adhesive strength is from a first comparison coacervate-based adhesive that replaces the dopamine-substituted silk fibroin solution with an unmodified silk fibroin solution and is otherwise identical to the coacervate-based adhesive, wherein the wet adhesive strength is at least 5% greater than the first comparison wet adhesive strength.

11. The coacervate-based adhesive of claim 1, wherein the coacervate-based adhesive has a dry adhesive strength that is greater than a second comparison dry adhesive strength, wherein the second comparison dry adhesive strength is from a first comparison coacervate-based adhesive that replaces the dopamine-substituted silk fibroin solution with a polyethylene glycol solution and is otherwise identical to the coacervate-based adhesive, wherein the dry adhesive strength is at least 25% of the second comparison dry adhesive strength.

12. The coacervate-based adhesive of claim 1, wherein the coacervate-based adhesive has a wet adhesive strength that is greater than a second comparison wet adhesive strength, wherein the second comparison wet adhesive strength is from a first comparison coacervate-based adhesive that replaces the dopamine-substituted silk fibroin solution with a polyethylene glycol solution and is otherwise identical to the coacervate-based adhesive, wherein the wet adhesive strength is at least 25% of the second comparison wet adhesive strength.

13. The coacervate-based adhesive of claim 1, wherein the dopamine-substituted silk fibroin has a degree of dopamine-substitution of between 5% and 50%, wherein the degree of dopamine-substitution is measured as a percentage by weight of dopamine substituents related to the weight of a silk fibroin backbone.

14. The coacervate-based adhesive of claim 1, wherein the dopamine-substituted silk fibroin is dopamine-substituted at one or more target amino acids, wherein the one or more target amino acids are selected from the group consisting of cysteine, tyrosine, arginine, lysine, histidine, phenylalanine, proline, and combinations thereof.

15. The coacervate-based adhesive of claim 1, wherein the dopamine-substituted silk fibroin is dopamine-substituted at one or more tyrosines.

16. The coacervate-based adhesive of claim 1, wherein the dopamine-substituted silk fibroin is substituted with a polydopamine having 15, polymeric units or less.

17.-24. (canceled)

25. The coacervate-based adhesive of claim 1, wherein the coacervate-based adhesive provides adhesion between two articles when submerged in either distilled water or simulated sea water.

26. The coacervate-based adhesive of claim 1, wherein the dopamine-substituted silk fibroin has a silk fibroin backbone with a weight average or number average molecular weight of between 25 kDa and 150 kDa.

27.-34. (canceled)

35. The coacervate-based adhesive of claim 1, wherein the coacervate-based adhesive provides adhesion between surfaces without addition of metal cations.

36. The coacervate-based adhesive of claim 35, wherein the coacervate-based adhesive provides stronger adhesion properties between surfaces upon addition of the metal cations.

37. The coacervate-based adhesive of claim 1, wherein the coacervate-based adhesive further comprises a therapeutic agent.

38. A method of using the coacervate-based adhesive of claim 1, the method comprising:
contacting two articles together with an adhesive amount of the coacervate-based adhesive, thereby adhering the two articles to one another.

39.-41. (canceled)
